(19) United States
(12) Patent Application Publication
(10) Pub. No.: US 2007/0289551 A1
(43) Pub. Date: Dec. 20, 2007

(54) Chew Toy Safety Indicator

(76) Inventor: Amy Marie Rockwood, Modesto, CA (US)

Correspondence Address: AMY ROCKWOOD, 217 LOIS AVENUE, MODESTO, CA, 95350, US

(21) Appl. No.: 11/760,774

(22) Filed: Jun. 10, 2007

Related U.S. Application Data
(60) Provisional application No. 60/804,749, filed on Jun. 14, 2006.

(51) Int. Cl. A01K 29/00

(52) U.S. Cl. 119/709; 119/710

(57) ABSTRACT

The “Chew Toy Safety Indicator” is a safety mechanism design for pet chew toys that is distinguished by having a green (color similar to the green in a traffic light) outer wear layer and a red (color similar to the red in a traffic light) inner layer. If the green wear layer is compromised to where the red can been seen from the outside of the chew toy, this indicates to the pet owner that the pet chew toy design is no longer safe for the pet to use. Using the well-known color-coding indicator system where “green means go” and “red means stop” should be the most recognizable and safest approach to chew toy safety. This “Chew Toy Safety Indicator” when combined with the toy's design for indestructibility should lesson or eliminate the possibility of blockages that historically have hurt and in worst case scenarios kill pets.

### CROSS-REFERENCE TO RELATED APPLICATIONS: “Not Applicable”

### FEDERALLY SPONSORED RESEARCH AND DEVELOPMENT: “Not Applicable”

### SEQUENCE LISTING, A TABLE, OR A COMPUTER LISTING COMPACT DISC APPENDIX: “Not Applicable”

### BACKGOUND OF THE INVENTION

The purpose of the “Chew Toy Safety Indicator” is to change pet chew toy technology for dogs and other pets so that the possibility of blockages (from ingestion of chew toys) in a pet's digestive track will be lessened or eliminated. The “Chew Toy Safety Indicator” is a mechanism for pet owners (primarily dog owners) to visually see a color change in the chew toy itself indicating that the toy design has been compromised. The universally known colors of “green for go” and “red for stop” are utilized in this inventive design.

Within U.S. Patent Classification Definitions, Class D30, Subclass 160, D21, 2., Toy is defined. This animal/dog/pet “Chew Toy Safety Indicator” design is unique.

A green outer layer (designed for high strength to pet chewing) and a red inner layer (also designed for pet chewing) in combination with a properly designed chew toy shape allows for the pet owner to visually see any change from the green “go” to the red “stop”. If, or when, the chew toy visually is red, it is an indication to take the toy away from the pet/dog.

Once any chew toy has changed or broken down from its original shape or design it becomes dangerous to the pet because it may be ingested. Once ingested the toy can cause a blockage in the pet's digestive track causing an emergency and in the worst cases, death.

There are literally hundreds of documents concerning chew toy ingestion as a result of the chew toy design breaking down, the chew toy being ingested, and causing illness or death. Documented examples include; “Nylabone Recall” by King 5 News—Seattle; “Buying Dog Toys and Chews That are Safe For Your Pet”, by www.livingwithadog.com; “Dog Toy Safety” by www.Wikepedia.org; “Choosing Safe dog Toys for Your Small Dog”, by www.kooldawgtees.com; “Alert! Chewies, How Safe are Your Chewies”, by Sylvia Hamilton at www.sentex.net; “Rawhide, Cow Hooves, Pig Ears, Greenies, Nylabones, Bullystick . . . What is Safe For My Dog?” by www.K911.biz; “Raw Hide Warning”, by www.boxerrescue.com. In the Boxer Rescue document they describe throwing the chew toy away when it gets “too small”. This is generally the advice from chew toy manufactures. The “Chew Toy Safety Indicator” now gives pet owners an exact indication of when the chew toy is “too small” or when the toy has been compromised, thus potentially saving the dog's life.

### BRIEF SUMMARY OF THE INVENTION

The purpose of the “Chew Toy Safety Indicator” is to change pet chew toy technology for dogs and other pets so that the possibility of blockages (from ingestion of chew toys) in a pet's digestive track will be lessened or eliminated. “The Chew Toy Safety Indicator” is a mechanism for pet owners (primarily dog owners) to visually see a color change in the chew toy itself indicating that the toy design has been compromised. The universally known colors of “green for go” and “red for stop” are utilized in this inventive design.

The “Chew Toy Safety Indicator” is manufactured by placing a color green (or traffic light color green) wear layer on the surface of the chew toy and a color red (or traffic light color red) hidden wear layer below the green wear layer. If, or when, the green wear layer is compromised or chewed through, the red can be seen that indicates to the pet owner that it is time to take the toy away from the pet.

Amy Rockwood, the inventor, is the 100% owner of GoughNuts LLC using this patent pending technology. The objective of the invention is to provide a safe chew toy mechanism or indicator to help prevent illnesses or death from pets ingesting large chunks of a chew toy. Furthermore, to entice or ensure pet owners take the chew toy away from the pet, if or when compromised, the company using this patent pending technology guarantees replacement parts free of charge.

Two important design details must accompany the “Chew Toy Safety Indicator” technology. First the chew toy must have real indestructible qualities. While a completely indestructible toy will probably never be achieved (as a result of factors including ozone and volume swell) the chew toy using the “Chew Toy Safety Indicator” has to withstand aggressive chewing to enable the pet owner to have time to see any visual indication of product breakdown. Secondly, the chew toy using the “Chew Toy Safety Indicator” should be made of a material that when chewed only breaks down in small pieces. Small pieces are defined as not larger than 0.5 cm in any direction of width, length, or thickness. Pieces of this size are easily passed though the digestive system if the pet eats them.

While many chew toy companies have quality chew toy properties none have a visual indicator. A visual indicator, manufactured into the chew toy, indicates to the owner when the toy has been compromised.

### BRIEF DESCRIPTION OF THE SEVERAL VIEWS OF THE DRAWING

Drawings—FIG. 1, and FIG. 2.

There are two drawings, FIG. 1 and FIG. 2.

FIG. 1 depicts a cross section view of a donut shaped toy, currently being sold by GoughNuts LLC, using the “Chew Toy Safety Indicator”.

FIG. 2 depicts a top view of this same donut shaped toy. The donut shaped toy is dimensioned and shows an outside diameter and an inside diameter. There are two main components within the toy shown in FIG. 1A labeled 1A and 1B and in FIG. 2 marked 2A and 2B.

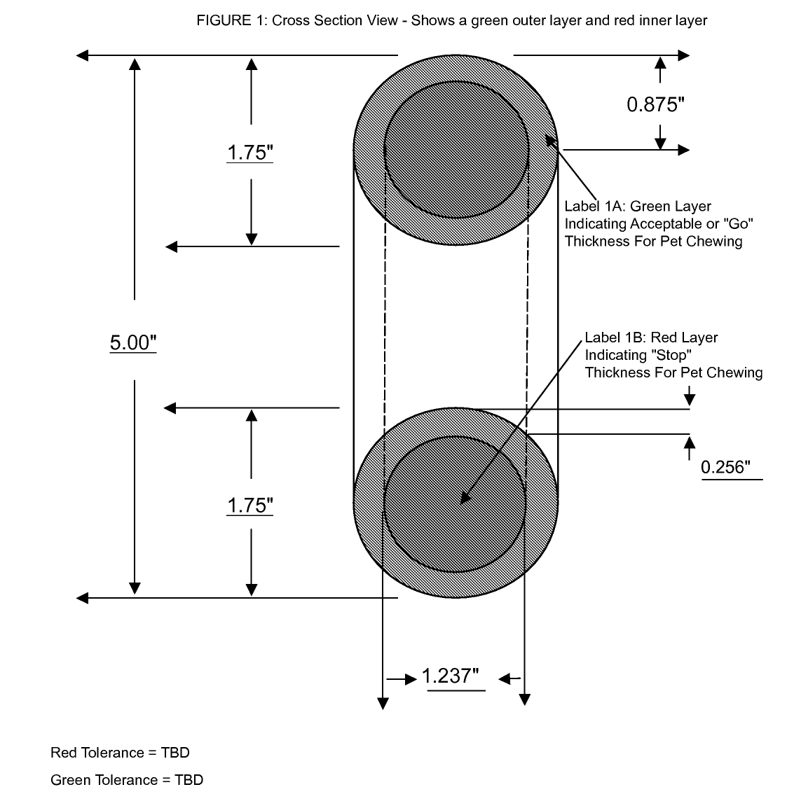

Label 1A, within FIG. 1, points to the green outside wear layer of the “Chew Toy Safety Indicator”. This outside green layer is designed to indicate that when the all green layer is seen it is safe for the pet to continue to chew.

Label 1B, within FIG. 1, points to the red inner wear layer of the “Chew Toy Safety Indicator”. This inside red layer is designed to indicate that if seen (the red layer seen through the green) it is time to take the toy away from the pet.

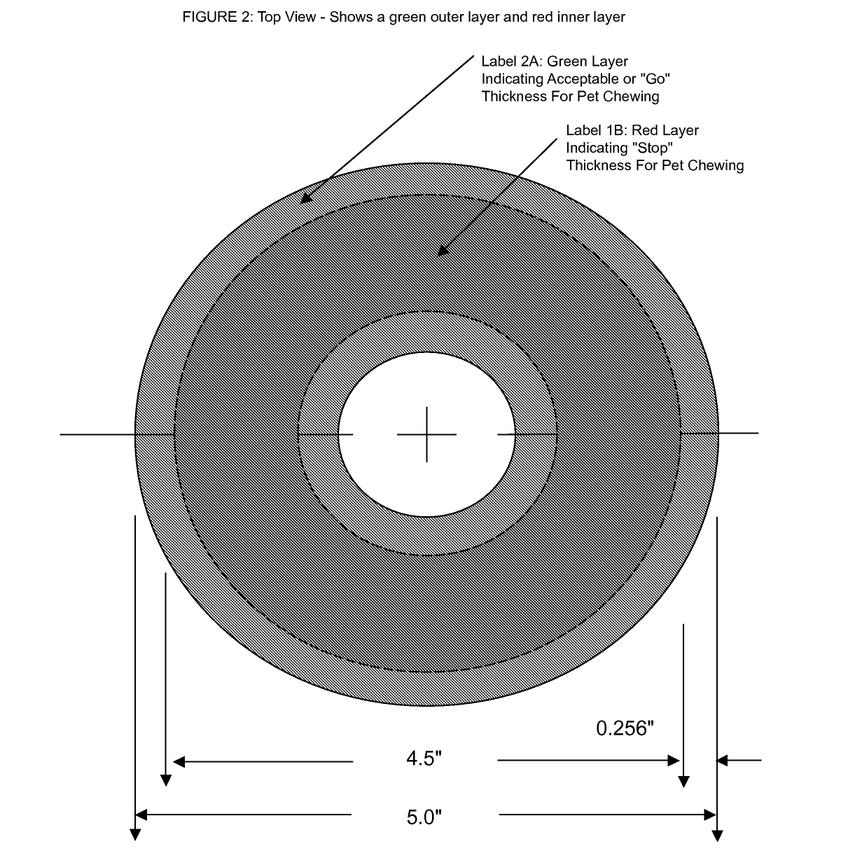

Label 2A, within FIG. 2, points to green outside wear layer of the “Chew Toy Safety Indicator”. This outside green layer is designed to indicate that when the all green layer is seen it is safe for the pet to continue to chew.

Label 2B, within FIG. 2, points to the red inner wear layer of the “Chew Toy Safety Indicator”. This inside red layer is designed to indicate that if seen (the red layer seen through the green) it is time to take the toy away from the pet.

### DETAILED DESCRIPTION OF THE INVENTION or DESCRIPTION OF PREFERRED EMBODIMENT

The purpose of the “Chew Toy Safety Indicator” is to change pet chew toy technology for dogs and other pets so that the possibility of blockages (from ingestion of chew toys) in a pet's digestive track will be lessened or eliminated. “The Chew Toy Safety Indicator” is a mechanism for pet owners (primarily dog owners) to visually see a color change in the chew toy indicating that the toy design has been compromised. The universally known colors of “green for go” and “red for stop” are utilized in this inventive design.

Patent Owner—Amy Rockwood, 100% Owner of, GoughNuts LLC.

Patent Invention—By implementing a “Chew Toy Safety Indicator” within a pet chew toy, pet owners will now have a clear visual indication if the pet toy's integrity has been compromised. This indication will be clearly visible if the pet (typically a dog) chews from one color to the next. The basic colors known throughout the world, “green for go” and “red for stop” will be used. This “Chew Toy Safety Indicator” technology can be clearly seen on drawings 1A and 2A.

The chew toy product instruction will state that when using the “Chew Toy Safety Indicator” if or when the pet chews through the green thickness causing the red indicating, “Stop” color is seen the pet owner should return the product to the manufacturer for replacement. If the pet owner does not want to return the chew toy for replacement, then the pet owner should throw the toy in the garbage. As stated above, if or when the red color is seen (assumes a pet has chewed through the green), this is an indication that the toy design has been compromised and is no longer safe for the pet to use as a chew toy.

The reality for dog or pet chew toys is that they can be made, intending to be indestructible, however, there will always be a small percentage of pets that will able to destroy the toy. Other factors play into the destruction of pet toys including volume swell (such as toys that are left in water) and weathering (such as toys that are left in the sun). Depending on the size of the ingested chew toy part, a blockage may occur in the pet's digestive track causing discomfort, possible need for removal by surgery, and in the worst-case scenario, death.

In order for the “Chew Toy Safety Indicator” to be functional the chew toy itself has to have real indestructible qualities. These indestructible qualities will allow for enough time for the pet owner to be able to see a “Safety Indicating Color Change” before the chew toy's integrity can be compromised.

Chew toy integrity described above is defined by the ability of the toy to maintain its function or not break apart. When or if the chew toy fails or breaks apart, the danger of ingestion and possible blockage occurs. The function of a chew toy is to allow a pet (typically a dog) to keep active using its instinctual chewing motion. This activity is instrumental in the pet's overall health.

The “Chew Toy Safety Indicator” patent design should cover not just the ID/OD donut design shown in FIGS. 1A and 2A but all chew toy designs in the pet industry. There will be many designs that will use this patent technology including a ball. Similar to the two color encapsulated donut shaped toy, the ball toy can use the “Chew Toy Safety Indicator” system where the Green layer of thickness will be on the outside and the Red will be the inner layer. As stated above, if the green layer is penetrated so that the red layer can be seen, this is the indication to the pet owner that the toy's integrity has been compromised. Again, any chew toy that has been compromised from its original design should be taken away from the pet.

This patent design should cover not only Thermoset and Thermoplastic rubber in pet chew toys but should include any raw material or finished product where there is a safety indication (indicating that the toy is being broken apart) by color or any recognizable change. Recognizable changes should include hardness or modulus differences (soft to hard or hard to soft), taste differences (a taste the pet likes to a taste a pet does not like), sound indicators (as the safety layer is removed a sound would indicate to the owner that the toy has been compromised) or texture differences (a texture the pet likes to a texture the pet doesn't like). This patent should cover any thickness of the wear layer whether it is thick or thin. Also, this patent design should cover designs that use any number of wear layers including three and four layers. The safety of the design could be enhanced by adding a third layer, colored yellow, placed between the green layer and the red layer to signal caution before the last layer of red was seen finally signaling a “stop”.

The below design descriptions allow for the “Chew Toy Safety Indicator” to be functional. The toy must function both as an engineered indestructible toy but also be attractive to the pet so that the pet's instinctual chewing can be satisfied.

A proper shape design, in combination with a durable thermoset rubber recipe, makes this dog toy virtually indestructible. Creating a shape that has diameters large enough so that a pet/dog cannot create pinch points are common for designs with the intent of a toy lasting or having an indestructible quality. Thermoset rubber typically involves the crosslink of organic molecules including the carbon, sulfur and silicon atoms. When a toy is black, carbon is used as a strong cross-linking atom.

Rubber Polymer selections for making durable pet chew toys include natural rubber and synthetic rubber. The filler systems may include precipitated silica, carbon black, magnesium carbonate, clay and others fillers. The plasticizers may include napthenic, aromatic, or paraffinic oils. The cross-linking systems may include peroxide or sulfur systems.

Using a proper sized cross section (sized for differing jaw size and power), prevents edges or weak points that are typically the reason why dog toys fail. When making toys using the “Chew Toy Safety Indicator” size of diameter for the toy in comparison to the dog's power and jaw size is critical. In general the larger the diameters of the toy, the safer it is for possible breakdown in the pet's jaws.

Thermoset or thermoplastic parts are made using common mixing and molding technology. The mixing can be accomplished using internal mixing, such a Banbury, or mill mixing. The molding of the toy can be accomplished using standard compression, transfer, and or injection molding.

A co-extruder would be used where the green color and the red color could be strip fed simultaneously. The co-extrusion process utilizes extrusion dies to shape each layer into the proper thicknesses. In the donut shaped part that uses the “Chew Toy Safety Indicator” the co-extrusion, with green on the outside and red on the inside, is cut to length and the ends are connected to encapsulate the red inside the green. The formed donut must be within 2% to 4% of the volume requirements of the mold to allow or not allow the rubber to deform in the molding process.

If using a co-extrusion process to form the green and the red layer, compression molding would be the only way to accomplish making the part to achieve the “Chew Toy Safety Indicator”. Compression molding utilizes an upper and a lower heated platen. The two platens are forced together using hydraulics to create pressure so that the material that is placed in the mold can flow and take shape. “Rubber Technology”, by Morten, is a common resource for beginners and experts alike to gain and review rubber-molding practices.

The theory of why this inventive idea has not happened or been previously invented in the pet industry before is in theory because of two reasons. These two reasons include, cost and a lack of understanding of problems of blockages that have been occurring in pets.

Making a two part or two layered pet toy utilizing the “Chew Toy Safety Indicator” will cost more to manufacture versus a one layer uniform or swirled colored material. Creating two distinct, separate and encapsulated colored layers, with the sole purpose of safety, is unique to the pet industry. In many cases the cost of manufacturing a pet toy using the “Chew Toy Safety Indicator” will not be economically possible. However, the demand for a safe toy will allow this technology to succeed. Amy Rockwood, the Inventor of the “Chew Toy Safety Indicator”, has experienced great interest and demand for a safe toy. This demand will create a market even though this toy will, no doubt, be sold at a higher price.

Pets have been and are growing in demand throughout world. There are police dogs, search and rescue dogs, guide dogs, herding dogs and many others. Anytime a pet and or working class animal becomes sick or dies from a blockage, as a result of ingestion of a chew toy, it is a tragedy. In addition to the emotional loss of the animal, the economic losses for Police dogs (as an example) can exceed $50,000 depending on the training of the animal.

The Internet has been a great tool to finally understand the number of problems and issues that are related to chew toy ingestion causing blockages. Now that we understand better the needs for safer pet toys, this inventive “Chew Toy Safety Indicator” idea will be a mechanism that should help to reduce the tragedies. When you start with great chew toy technology, in combination with the “Chew Toy Safety Indicator” technology, the result is a great, safe product that pet owners will value.

FIG. 1A depicts a cross section of a donut design, currently sold by GoughNuts LLC (small entity), where Amy Rockwood, the inventor and 100% owner, showing the two distinct wear layers of Green and Red. The label in FIG. 1 labeled 1A points and describes the green wear layer. The label in FIG. 1 called 1B points and describes the red wear layer.

FIG. 2 depicts a top view of a donut design, currently sold by GoughNuts LLC (small entity); where Amy Rockwood, the inventor and 100% owner, showing the two distinct wear layers of Green and Red. The label in FIG. 2A labeled 2A points and describes the green wear layer. The label in FIG. 2 labeled 2B points and describes the red wear layer.

The Donut design shown in FIG. 1 and FIG. 2 is the first designed pet toy to incorporate the “Chew Toy Safety Indicator”. The “Chew Toy Safety Indicator” idea is a safety mechanism that can and will be incorporated in many pet chew toy designs.

1. The purpose of this patent idea is to change pet chew toy technology for dogs and other pets so that the possibility of blockages, from ingestion of chew toys, in a pet's digestive track will be lessened or eliminated.

2. Patent Invention—By implementing a visual indicator within the chew toy itself, pet owners will have a clear visual indication if the pet toy's integrity has been compromised. This indication will be clearly visible if the pet (typically a dog) chews from one color to the next. The basic colors known throughout the world, “Green for Go” and “Red for Stop” will be used.

3. The product instruction will state that, when using the, “Chew Toy Safety Indicator”, if or when the pet chews through the green thickness where by the red indicating, “Stop” color is seen; the pet owner should stop allowing the pet to chew on the chew toy and return the product to the manufacturer for replacement. If the pet owner does not want to return the chew toy for replacement then the pet owner should discard or not allow the pet to further chew on the toy. If or when the red color is seen (assumes a pet has chewed through the green), this is an indication that the toy design has been compromised and is no longer safe for the pet to use as a chew toy.

4. The reality for dog or pet chew toys is that they can be made, intending to be indestructible, however, there will always be a small percentage of pets that will able to destroy the toy. Depending on the size of the ingested chew toy part, a blockage may occur in the pet's digestive track causing discomfort, possible need for removal by surgery, and in the worst-case scenario, death. In order for the “Chew Toy Safety Indicator” to be functional, the chew toy itself has to have real indestructible qualities. These real indestructible qualities will allow for enough time for the pet owner to be able to see a “Safety Indicating Color Change” before the chew toy's integrity can be compromised. Chew toy integrity described above is defined by the ability of the toy to maintain its function or not break apart. When or if the chew toy fails or breaks apart the danger of ingestion and possible blockage occurs.

5. The “GoughNuts Safety Indicator” patent design should cover not just the ID/OD donut design but all chew toy designs in the pet industry. There will be many designs that will use this patent technology including a ball. Similar to the ID/OD, two color encapsulated donut shaped toy, the ball toy will use the “Goughnuts Safety Indicator” system where the green layer of thickness will be on the outside and the red will be the inner layer. As stated above, if the green layer is penetrated so that the red layer can be seen, this is the indication to the pet owner that the toy's integrity has been compromised. Again, any chew toy that has been compromised from its original design should be taken away from the pet.

6. This patent should cover not only Thermoset and Thermoplastic rubber in pet chew toys but should include any raw material or finished product where there is a safety indication (indicating that the toy is being broken apart) by color or any recognizable change. Recognizable changes should include hardness or modulus differences (soft to hard or hard to soft), taste differences (a taste the pet likes to a taste a pet does not like), sound indicators (as the safety layer is removed a sound would indicate to the owner that the toy has been compromised) and or texture differences (a texture the pet likes to a texture the pet doesn't like). This patent should cover any thickness of the wear layer whether it is thick or thin.
